(19) United States
(12) Patent Application Publication
(10) Pub. No.: US 2026/0225063 A1
(43) Pub. Date: Aug. 6, 2026

(54) HIGH SPEED CONTINUOUS FLOW REACTOR FOR HYDROCARBON REFORMING

(71) Applicant: The Texas A&M University System, College Station, TX (US)

(72) Inventors: David Staack, College Station, TX (US); Md Abdullah Hil Baky, Bryan, TX (US); Kunpeng Wang, College Station, TX (US); Howard Jemison, Houston, TX (US)

(73) Assignee: The Texas A&M University System, College Station, TX (US)

(21) Appl. No.: 19/149,322

(22) PCT Filed: Jan. 30, 2024
(86) PCT No.: PCT/US2024/013591

§ 371 Date: Jul. 18, 2025

Related U.S. Application Data
(60) Provisional application No. 63/442,238, filed on Jan. 31, 2023.

(51) Int. Cl. B01J 19/08; C10G 32/02

(52) U.S. Cl. CPC B01J 19/088; C10G 32/02; B01J 2219/0809; C10G 2300/1081

(57) ABSTRACT

An apparatus for reforming hydrocarbons includes a reaction chamber including a hydrocarbon inlet, a plurality of plasma gaps, each plasma gap defined by a high voltage electrode and first and second ground electrodes, and a product outlet. The reaction chamber may have a first head space about a first plasma gap located proximal to the hydrocarbon inlet and a second head space surrounding a last plasma gap located proximal to the product outlet, with the second head space larger than the first head space. A flow rate and/or pulse frequency can be determined to obtain a desired product at an acceptable efficiency with limited or negligible production of undesired products. A reaction system can comprise multiple reaction modules connected in parallel and/or in series, with conduits between reaction modules. One or more (or all) conduits may include gas off-leaks. Each reaction module may include a reaction chamber with increasing headspace.

### CROSS-REFERENCE TO RELATED APPLICATIONS

This application claims the benefit of U.S. Provisional Patent Application No. 63/442,238 filed Jan. 31, 2023, the entirety of which is herein incorporated by reference.

### FIELD

The present technology is generally related to a high velocity continuous flow plasma reactor system for economically converting liquid and gaseous hydrocarbons to higher value products such as, but not limited to hydrogen (H₂), lighter gasoline and diesel range hydrocarbons, modified octane, and other desirable organics.

### BACKGROUND

Crude oil, the largest contributor to the global energy supply in the last half century, continues to hold the largest share of energy in 2020. In spite of world energy consumption declining by 4.5% in 2020 compared to previous year due to COVID 19, and oil demand decreasing by 9.3%, crude oil still contributed to 31.2% of the global energy demand, higher than any other energy source. [1] Since the use of oil is mainly based in the transportation and petrochemical industry and is challenging to replace, crude oil is expected to be the major energy contributor over the next few decades and will result in demand of liquid fuels being 95 million barrels per day in 2050 if government policies, technologies and social preferences continue to evolve in a manner and speed seen over the recent past. [2] However, the supply of crude oil will be severely limited with the global crude oil reserve to be at 1.732 trillion barrels and expected to last only another 47 years, thus making the international competition for crude oil resource fierce. [1] Therefore, crude oil processing is of great interest to academics and researchers. [3]

The purpose of refineries is to convert raw crude oil into more economic and useful fuels and petrochemicals. The crude oil is first washed in a desalter and heated before it enters the fractionators (e.g. atmospheric crude fractionator and vacuum fractionator), where its components are separated based on their boiling point, without any chemical reaction or use of catalysts. Separated components go through various downstream equipment such as pumps, compressors, heat exchangers, reactors, and distillation columns etc. to be converted from one product to blends of different products with required specifications, such as octane and gasoline.

To alleviate fouling and corrosion of crude oil vessels and piping system and to prevent catalysts poisoning in the later stages, the crude oil needs to be desalted first after it arrives at the refinery. For desalting, the crude oil is mixed with water to dissolve the salts and sediments. The dissolved brine is separated from the oil with the help of electric grid in the desalter vessel. The desalted crude is heated to 650-700° F. by several heat-exchangers and fired heaters, before it enters the atmospheric fractionator. In the atmospheric crude fractionator the desalted and heated crude are separated into fractions based on their boiling points. Lighter fractions are collected from the top of the tower and heavier fractions with higher boiling points are collected from the side of the tower. Each side draw has an initial boiling point and an end boiling point specific to the downstream units. Typical boiling cut points are light naphtha: 90-190° F., heavy naphtha: 190-330° F., kerosene: 330-480° F., light atmospheric gas oil: 480-610° F., heavy atmospheric gas oil: 610-800° F., vacuum gas oil: 800-1050° F., vacuum reduced crude: higher than 1050° F. The heavy, high boiling point residuum from bottom draw is sent to vacuum column for further separation. The vacuum fractionator separates the high boiling point fractions under a vacuum and thus preventing thermal cracking since lower pressure decreases the boiling point. The vacuum fractionator is larger in diameter since vaporized crude hold more volume under vacuum.

Saturated Gas Concentration units collects the light hydrocarbon leaving the top of the atmospheric fractionator columns and are concentrated and separated. Separated gases are categorized into wet gases (e.g. propane and butane) and dry gases (e.g. methane and ethane). Fired heaters and boilers across the refinery are primary users of the dry gases.

Heavier, long chain hydrocarbon fractions from the fractionator, such as heavy gas oil, go to the fluidized catalytic cracker (FCC) to be cracked into shorter and lower boiling range hydrocarbons. The FCC uses fine catalysts that flows like a fluid and reacts with the feed at 900-1000° F. The reaction is endothermic and uses heat from catalyst regenerator. The temperature at the exit of regenerator is about 1000 to 1500° F. and is an obvious part of the process since 5 wt % of the feed ends up as coke on the catalysts and the catalysts must be regenerated. Cracked hydrocarbon vapor from the FCC reactor is separated and recovered at FCC fractionator downstream of the FCC reactor.

Olefins from the FCC, and sometimes from a coker, along with isobutane from a butane isomerization unit, are the feed to alkylation unit where isobutane combines with olefins to form alkylate to use with gasoline blending for octane number improvement. Iso-butane is preferable over n-butane for octane rating improvement. Butane isomerization and olefin alkylation take place in the same unit where alkylate is collected from the bottom of the column, n-butane is taken as side draw and isobutane is collected from the top. Similar to butane isomerization unit, light naphtha isomerization unit converts n-pentane and n-hexane into iso-pentane and iso-hexane with the help of excess hydrogen and catalysts.

While these traditional cracking technologies e.g., FCC, hydrocracking, delayed coker etc. that have been in practice for ages and offer certain advantages, they come with noticeable downside as well. These technologies can generate large range of fuel from light kerosene to heavy oil in large quantities but at the cost of heavy financial investment. All these processes are most efficient at very large scale therefore they require large capital expenditures and operating costs. An estimated size of an efficient full range refinery is about 200 thousand barrels per day of crude oil, at the low end. The capital cost of a reforming unit, such as a hydrotreater, is also very expensive. A hydrotreater is about 5 times more expensive than an atmospheric distillation column with respect to capital cost for the same processing rate capacity. Also, such units require high temperatures and pressures that require special materials, such as heavy-duty alloy steel, and other equipment to manufacture the reactor chambers for these processes to withstand the extreme processing conditions. Also, the catalysts used in the cracking processes are prone to quick degradation by the impurities in the crude oil. For example, the presence of sulfur in the crude degrades the effectiveness of the catalysts. Therefore, de-sulfurization and catalysts regeneration are very important added steps to traditional cracking technologies which greatly adds to the capital cost.

Plasma chemical methods for reforming are a promising alternative to tradition crude oil processing technologies. Plasma is the fourth state of matter after solid, liquid and gas. Plasma is defined as an ionized gas that consists of ions, electrons, neutrals, radicals, and excited molecules. An ionized gas is called plasma if it is quasi-neutral, and its properties are dominated by electric and/or magnetic forces. Plasma can be generated by heating the gas to very high temperature or applying strong electromagnetic field to a gas. Chemically and physically active species in the plasma makes them particularly interesting for chemical processing in industry. Ozone production, surface treatment and gas cleaning are one of many fields where plasma technology have been used industrially. Studies have been performed using plasma technology to reform or process light oil to generate hydrogen rich gas for vehicle fuel cell or syngas. [4-6] Plasma processing is being studied to be introduced into heavy oil upgrading to address some of the challenges of traditional hydro-processing including requirement of expensive catalysts. Different types of electrical discharges are used to generate plasma which breaks the hydrocarbon bonds in the crude oil. Cracking and reforming using plasma have been studied and published in various research and publications.

Plasmas can be categorized as thermal (i.e. hot) or non-thermal (i.e. cold), depending on whether the gas temperature of plasma is as high as the combustion temperature. In a thermal plasma, the electron temperature is as high as the temperature of the heavy species (ions and neutrals), while in a non-thermal plasma, electron temperature is much higher than heavy species temperature. Power requirement for thermal plasma is very high (several kilowatts) and plasma temperatures are usually higher than 1000° C. Therefore, thermal plasmas are generally used to generate gaseous hydrocarbon such as ethylene, acetylene, and syngas. Because of high temperature and high-power requirements, thermal plasmas may not always be economically feasible. Cold plasma, on the other hand, can be generated at or close to atmospheric temperature and pressure with much lower input power. It is more energy efficient and has the potential for commercial application. It has been studied for heavy oil upgrading.

Hao et. el. [7] proposed a process for upgrading heavy oil using non-thermal plasma technology in a conventional thermal cracking system under atmospheric pressure. Their system used a cylindrical dielectric barrier discharge (DBD) reactor which was preheated to 200° C. with 200 g test sample. A reaction gas was fed continuously through the bottom of the reactor bubbling through the heavy oil. The trap oil yield for plasma on and plasma off conditions has be determined for various feed gases, and the result indicated that trap oil yield increased for plasma on condition by ~9% with N₂ gas and ~19% for H₂ and CH₄ gas. It has been observed that plasma on conditions have higher (H/C) . . . and fewer hetero atoms. Analysis of the redistribution of H and C atom implies mainly side chain losses and bridged bond breakage resulting in lower molecular weight of residue compared to feedstock for plasma on conditions. Taghvaei et el. [8] studied the production of hydrogen through plasma cracking of hydrocarbon with nano-second pulsed dielectric barrier discharge (DBD) to analyze the effect of hydrocarbon feed chain and carrier gas type. C1-C16 straight chain alkanes were used to analyze the effect of hydrocarbon feed chain length. The study concluded that non-thermal plasma is effective in cracking long range of light to heavy hydrocarbon into hydrogen. The reactor performance increases with the increase of hydrocarbon feed carbon number. Hydrogen cracking is more efficient in argon compared to argon-methane mixture since in the latter case energy is consumed by the dissociation of methane molecules. However, DBD reactors are more complicated and expensive to scaleup compared to spark discharge reactors that the current patent proposes. DBD plasma is more sensitive to solid impurities and produces more coke than spark discharge.

U.S. Pat. No. 7,931,785 [9] describes methods for converting heavy crude into lighter fractions with high conversion efficiency. The methods include subjecting heterogeneous gas-oil mixtures to electron beam and non-self-regulatory electric discharge. The methods are challenging to execute because of the complexity of the heterogeneous mixture preparation system. The requirement of an electron accelerator with a device output electron beam of the accelerator vacuum chamber in a gas liquid high pressure mixture also makes these methods challenging. The capital and operating costs of the system increases significantly because of the complicated electron accelerator. Also, use of fast electron beam is accompanied by a bremsstrahlung X-ray which requires the entire system to be biologically protected thus increasing the cost further. The technology proposed in this patent uses nano-second pulsed spark discharge which reduces the capital, operating and maintenance cost significantly.

U.S. Pat. No. 9,988,579 [10] describes a process for cracking liquid hydrocarbon by pulsed electrical discharges and proposed a device for its implementation. In this device a carrier gas in injected into a liquid hydrocarbon to create a multiphase mixture. Two electrodes are placed in the gas-liquid mixture maintaining a known inter electrode gap. A spark discharge is generated between the electrodes in the multiphase mixture using a resistor-capacitor circuit. The capacitor is charged to the breakdown voltage of the hydrocarbon mixture and discharged resulting in energy deposition into the hydrocarbon bonds. A lower molecular weight hydrocarbon than the initial hydrocarbon is thus generated. The discharge chamber is maintained at atmospheric pressure and at or slightly elevated temperature than room temperature. This patent deals with processing small amount of liquid hydrocarbon in laboratory scale and does not resolve the challenges brought up by large scale hydrocarbon reforming. Technology proposed in the current patent takes the high rate of processing volume into account and resolves the associated issues efficiently.

US Patent No 2021/0155855 A1 [11] provides a process for treating a liquid hydrocarbon by injecting a carrier gas comprising Hydrogen and Methane into the liquid. Kunpeng et el. [12, 13] treated hexadecane using this method in a non-thermal plasma reactor to validate conversion chemistry of liquid hydrocarbon by plasma reforming and quantified the pathways to vapor, condensate, liquid and residue mass conversion. They have deposited 1% of hexadecane's energy content though electrical discharge and analyzed the conversion products. Plasma-chemical conversion efficiency in their process turned out to be nearly 30% with minimal GHG emission compared to traditional technologies. In other works [14] Kunpeng et el. proposed model to simulate and estimate breakdown voltage and energy deposition in each phase of multiphase discharges. The multiphase model for predicting the breakdown voltage in liquid-gas phase is a superposition of power and meek criteria with empirically derived coefficients. According to the model the primary factor for determining the breakdown voltage is the gap spacing between electrodes. They have also analyzed the role of bubbles and impurities in breakdown of dielectric liquids. [15] The technology is these publications are more focused on treating heavy hydrocarbon efficiently using plasma energy whereas the technology in this patent focuses on doing the same but with a high processing intensity, higher throughput on an individual discharge gap, and more efficient distribution of gas injection and flow management hardware. All these effects make the current concept more easily scaled, lower capital cost and more efficient as a system.

Patent publication No. WO/2021/188650 [16] describes a method for converting heavy hydrocarbons to light hydrocarbons by generating a foaming mixture of liquid and gaseous hydrocarbon. To generate foam a gaseous hydrocarbon is compressed to liquid and mixed with a heavy hydrocarbon liquid. The mixture is then depressurized in a plasma chamber where the foaming mixture undergoes electrical discharge. The discharge is controlled to maintain a known energy deposition into the hydrocarbon mixture. Plasma reforming of liquid hydrocarbon is more efficient when the surface area between the liquid and gaseous hydrocarbon is high. Foam maximizes the surface area therefore the suggested method is supposed to increase the efficiency of heavy hydrocarbon conversion. The focus of this prior technology is therefore to increase the efficiency of conversion by increasing the transport of reactive species at the gas liquid interface whereas the proposed technology in this patent focuses on reforming higher feedthrough of liquid hydrocarbon faster and more efficiently by increasing the local fluid velocity to allow for higher discharge frequency.

Plasma chemical reactors have the potential to be used as a part of refinery upgrading technology. Implementing such reactors in the refinery process is simpler compared to field implementation since for refinery application the oil to be processed through these reactors will already have gone through dewatering, desalting, and distillation processes. Since the feed into these reactors will be preprocessed and distillated, reactors will not have to be rated for viscosity, density, olefin content and stability as would be needed in field implementation. Necessary power and carrier gas can be provided from the refinery itself without needing for much upgrading process. Refineries will have smoother process chain with increase in the production of desired distillates and decreased load on coker and hydrotreater.

### SUMMARY

In one aspect, an apparatus for reforming hydrocarbons includes a reaction chamber including a hydrocarbon inlet, a plurality of plasma gaps, each plasma gap being defined by a high voltage electrode and a first and second ground electrode, and a product outlet, where the reaction chamber has a first head space surrounding a first plasma gap located proximal to the hydrocarbon inlet; the reaction chamber has a second head space surrounding a last plasma gap located proximal to the product outlet; and the second head space is larger than the first head space. In any such embodiments, the reaction chamber may include a sloped (or otherwise increasing) headspace from the hydrocarbon inlet to the product outlet.

In any of the disclosed embodiments, the high voltage electrode is connected to a pulsed power source configured to deliver a pulsed discharge in the plasma gap of, for example, 300 Hz to 1000 Hz. In some embodiments, a first ground electrode is directly opposing and spaced apart from the high voltage electrode by a gap distance, d, and the second ground electrode is offset to the side of the high voltage electrode also by the gap distance, d.

In any of the disclosed embodiments, the reactor chamber is a first reaction chamber of a first reaction module, and the apparatus includes a second reaction module having a second reaction chamber, the first reaction module connected to the second reaction module.

In any of the disclosed embodiments, the hydrocarbon inlet is a first hydrocarbon inlet of the first reactor module, the product outlet is a first product outlet of the first reactor module, the second reactor comprises a second hydrocarbon inlet and a second product outlet, and the first product outlet is connected to the second hydrocarbon inlet by a conduit.

In any of the disclosed embodiments, the first reaction module is connected to the second reaction module by a first conduit comprising a first gas off-take. The apparatus may include a third reaction module connected to the second reaction module by a second conduit that comprises a second gas off-take.

In any of the disclosed embodiments, the hydrocarbon inlet is a first hydrocarbon inlet of the first reactor module, the product outlet is a first product outlet of the first reactor module, the first reaction chamber comprises a first sloped headspace from the first hydrocarbon inlet to the first product outlet, and the second reaction chamber comprises a second sloped headspace from a second hydrocarbon inlet to a second product outlet.

In another aspect, a reactor system includes a plurality of the apparatus of claim 1, wherein between any two adjacent apparatuses is located a conduit from which gas may be exited from the system.

In a further aspect, a method for reforming hydrocarbons includes introducing a C₁-C₄ hydrocarbon to a reaction chamber, wherein the reaction chamber comprises: a hydrocarbon inlet; a plurality of plasma gaps, each plasma gap being defined by a high voltage electrode and a first and second ground electrode; and a product outlet; applying a pulsed power source at a frequency of about 300 Hz to about 1000 Hz to each of the high voltage electrodes in the reaction chamber to form a plasma discharge at each plasma gap and to form a product stream comprising hydrocarbons having greater than C₄.

In any of the disclosed embodiments, the reaction chamber may have a first head space surrounding a first plasma gap located proximal to the hydrocarbon inlet, the reaction chamber has a second head space surrounding a last plasma gap located proximal to the product outlet, and the second head space is larger than the first head space. In any of the above embodiments, the frequency may be about 500 Hz to about 1000 Hz.

Any of the disclosed embodiments may comprise determining a velocity for the introduction of the C1-C4 hydrocarbon to the reaction chamber.

Any of the disclosed embodiments may comprise determining the frequency for applying the pulsed power source.

Any of the disclosed embodiments may have a reaction chamber with a headspace that is greater at the hydrocarbon inlet of the reaction chamber than at the product outlet of the reaction chamber.

In any of the disclosed embodiments, the reaction chamber comprises a sloped headspace from the hydrocarbon inlet to the product outlet.

In any of the disclosed embodiments, the reaction chamber is a first reaction chamber of a first reaction module, the hydrocarbon inlet is a first hydrocarbon inlet, the plurality of plasma gaps is a first plurality of plasma gaps, the product outlet is a first product outlet. Introducing the C₁-C₄ hydrocarbon to the first reaction chamber introduces the C₁-C₄ hydrocarbon to a system comprising the first reaction module and a second reaction module having a second reaction chamber with a second hydrocarbon inlet and a second product outlet. The product stream may be received from the second product outlet.

In any of the disclosed embodiments, the first reactor module is connected to the second reactor module by a conduit comprising a gas off-take to release at least a portion of gas generated in the first reaction chamber.

In any of the disclosed embodiments, the system comprises a first conduit connecting the first reaction module to the second reaction module, the first conduit having a first gas off-take, and a third reaction module is connected to the second reaction module by a second conduit having a second gas off-take.

In any of the disclosed embodiments, the reaction chamber is a first reaction chamber of the first reaction module, the second reaction module includes a second reaction chamber, and the first and second reaction chambers include headspaces that increase in size from inlet to outlet.

In various embodiments, the disclosed approach provides at least three innovative aspects. In one aspect, various embodiments include selection of flow rates and pulsing frequencies for obtaining desired products efficiently and with reduction of (or avoidance of) undesirable products (e.g., soot) relative to desired products. In another aspect, various embodiments employ a reactor with multiple reactor modules (each reactor module having a reactor chamber), with a gas off-take between each pair of reactor modules. In yet another aspect, various embodiments include reactor chambers with increasing headspaces, such as each reactor unit including a reactor chamber with a volume that increases from an upstream portion (e.g., intake) of the reactor unit to a downstream portion (e.g., outlet) of the reactor unit.

In various embodiments, the disclosed approach presents a pioneering processing system designed to accommodate larger volumes of liquid hydrocarbon input, thus facilitating the transition of previously developed laboratory-scale technology to an industrial-scale application. The system may employ a high-capacity reactor capable of sustaining extremely high pulsing frequencies at elevated hydrocarbon flow rates.

### BRIEF DESCRIPTION OF THE DRAWINGS

FIG. 1 is a schematic illustration of a plasma reforming system, according to various embodiments. FIG. 1 depicts a first ground electrode 105, a second ground electrode 110, a high velocity inlet 115, a high velocity outlet 120, a carrier gas inlet 125, and an insulated metal 130, with first diameter d₁, second diameter d₂, and third diameter d₃.

FIG. 2A is an illustration of three reactor units connected in in series, for a series of 12 spark gaps, according to one embodiment. FIG. 2B is an illustration of a single reactor unit with four spark gaps, according another embodiment. FIG. 2C is a side view of the reactor unit of FIG. 2B, according to various embodiments.

FIG. 3 is a schematic illustration of a plasma reforming system, according to various embodiments.

FIG. 4 is a schematic illustration of a plasma reforming system, according to various embodiments.

FIG. 5A is a dual curve graph of voltage versus time and current versus time from a reactor of 10 spark gaps according to examples. In FIG. 5A, plot 510 corresponds to voltage and plot 520 corresponds to current. FIG. 5B is a graph of current versus time showing current peaks over a period of 0.05 seconds for a pulsing frequency of 359 for 10 gaps, or about 36 pulses per spark gap per second, according to the examples.

FIG. 6 is a schematic illustration of a plasma reforming chamber showing an offset ground electrode to ensure discharge through multiphases instead of a single phase, with fourth distance d₄ between adjacent 130s, according to various embodiments.

FIG. 7A is a schematic illustration of a single spark gap in an open channel flow configuration, and FIG. 7B is a side view of the open channel flow, according to various embodiments. FIG. 7C is an illustration of a plasma discharge apparatus in an inclined open channel multi-electrode system, according to various embodiments. FIG. 7C illustrates ground electrodes 750, high voltage (HV) electrodes 755, flow inlet 760, flow outlet 765, inclination angle theta 770, and plasma discharge 775.

FIG. 8A is a schematic illustration of a plasma chamber having an increasing headspace from feed (i.e., flow in) to vent (i.e., flow out) for generated products, and FIG. 8B is an illustration of a plasma reactor chamber with gas off-take in between reactor units, according to various embodiments. FIG. 8A depicts ground electrodes 805, HV electrodes 810, flow in 815, flow out 820, gas out 830 (used synonymously with “gas off-take”), and increasing headspace 840. FIG. 8B depicts flow in 850, flow out 855, a first gas off-take 860 from a first conduit connecting first and second reactor modules, and a second gas off-take 865 from a second conduit connecting second and third reactor modules.

FIG. 9 depicts a plasma reactor with three reactor units, each reactor unit with a reactor chamber that has a headspace that increases in size from feed to vent, according to various embodiments. In FIG. 9, reaction chambers with increasing headspace 905 are depicted. As illustrated in FIG. 9, a first (upstream) side or end of the reaction chamber has a first height (h₁) and a second (downstream) side or end of the reaction chamber has a second height (h₂) that is greater than the first height (e.g., due to sloping headspace).

FIG. 10 depicts discharge in multiple electrode gap in an operational reactor, according to various embodiments.

FIG. 11 provides voltage (1110) and current (1120) traces from the power supply during an experiment, according to various embodiments.

### DETAILED DESCRIPTION

Various embodiments are described hereinafter. It should be noted that the specific embodiments are not intended as an exhaustive description or as a limitation to the broader aspects discussed herein. One aspect described in conjunction with a particular embodiment is not necessarily limited to that embodiment and can be practiced with any other embodiment(s).

As utilized herein with respect to numerical ranges, the terms “approximately,” “about,” “substantially,” and similar terms will be understood by persons of ordinary skill in the art and will vary to some extent depending upon the context in which it is used. If there are uses of the terms that are not clear to persons of ordinary skill in the art, given the context in which it is used, the terms will be plus or minus 10% of the disclosed values. When “approximately,” “about,” “substantially,” and similar terms are applied to a structural feature (e.g., to describe its shape, size, orientation, direction, etc.), these terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

The use of the terms “a” and “an” and “the” and similar referents in the context of describing the elements (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the embodiments and does not pose a limitation on the scope of the claims unless otherwise stated. No language in the specification should be construed as indicating any non-claimed element as essential.

This technology uses short duration (nano-second pulsed spark discharge) plasma to reform heavy hydrocarbon using electrical energy. The electrical energy can come from renewable energy sources and since this hydrocarbon reforming technology doesn't include any natural gas burning for heat generation like the conventional hydrocarbon reforming technology does, greenhouse gas emission from this technology is significantly less than traditional technologies. This technology can handle high throughput of liquid hydrocarbon and thus can be scaled from laboratory to industrial scale efficiently whereas the conventional technologies are only efficient at very large scale. A high speed continuous flow is maintained in this system to ensure high pulsing frequency. The high fluid velocity is necessary for carrier gas bubble residence time to be shorter than the time between consecutive discharges in each electrode gap. The same gas bubble in the same electrode gap can not be hit by multiple discharges in order to avoid glow discharge phase initiation and overprocessing of gas liquid hydrocarbon mixture. Overprocessing will lead to too many carbon being separated from the long hydrocarbon chain than desired and will result in undesired amount of soot formation.

Various embodiments provide a high-speed continuous flow plasma processing reactor for hydrocarbon reforming using, for example, efficient Cockcroft-Walton Generator (CWG) [further discussed in reference 17, WO2019204736] circuit power packs which generates spark discharges across a two-electrode gap in a multiphase liquid hydrocarbon-gas mixture using a high-voltage rectified DC supply to discharge a capacitor. Discharge is controlled to generate very high pulsing frequency (e.g., on the order of 300-1000 Hz, or from about 500-1000 Hz in other embodiments) and the hydrocarbon feed flow rate is controlled with a pump, which is controlled by a variable frequency drive (VFD), to avoid processing the same feed within the same electrode gap. In various embodiments, depending on the desired products, pulsing frequencies above 1 kHz may be employed. For example, frequencies between about 2 kHz and about 3 kHz may be employed. Increased frequency corresponds to higher flow velocity. At some point the flow velocity will result in a cavitation number greater than one which is a mode change in the system. The DC supply to run the CWG circuits may run off of a standard electrical supply line (e.g. 120 VAC or 240 VAC, 60 Hz single phase or multi-phase). The reactor is scalable to any number of discharge gaps to treat any amount of feed hydrocarbon while maintaining the similar pulsing characteristics.

In various embodiments, to efficiently reform heavy hydrocarbon liquids into lighter hydrocarbons with the presence of electric discharge, a feasible reactor chamber is required. In the chamber, a carrier gas is injected into heavy oil to form a multiphase region. A high potential difference is generated in an inter electrode gap in the multiphase region to eventually ionize the mixture in the gap. The high voltage electrical discharge cracks the heavy hydrocarbon into lighter hydrocarbons and the lighter hydrocarbons are recovered.

The current technologies for plasma processing liquid hydrocarbon includes a plasma chamber where a carrier gas flows through a stationary or slowly moving liquid hydrocarbon or a foaming mixture of hydrocarbons. The mixture is subjected to a potential difference between the electrodes sufficient to ionize the mixture and cause a discharge. Energy deposition in each discharge may be controlled by the size of the capacitor and the breakdown voltage. Too high of an energy per pulse would result in soot formation, while too little energy would affect the efficiency of the process. A specific amount of energy is deposited into the material to ensure a targeted chemical conversion.

One consideration for scaling of a laboratory hydrocarbon processing to an industrial scale using electrical discharge is that the feedthrough volume will need to be significantly large. To handle the volumes of liquid hydrocarbon for such batch reactors as described herein, the number of reactors (e.g., reactor units) will have to be very high. A reactor is thus required that will be able to handle feedthrough on the order of, for example, a barrel per day, allows ease of manufacturing, and minimizes process handling.

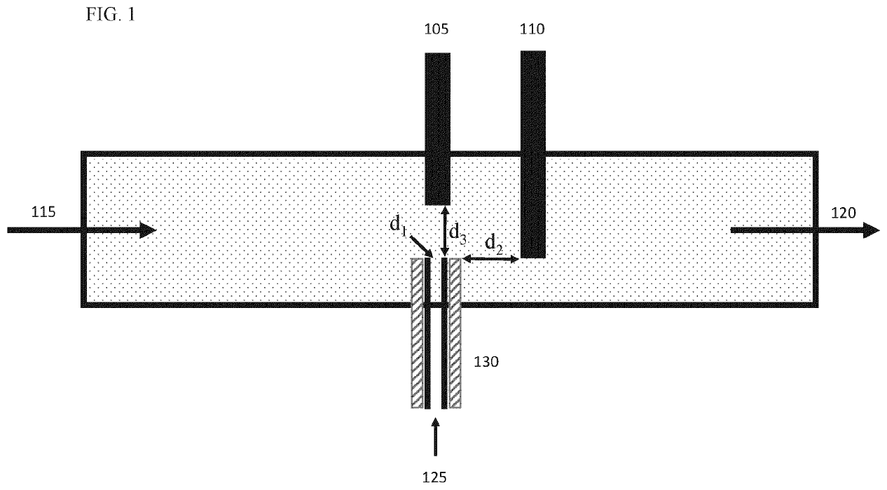

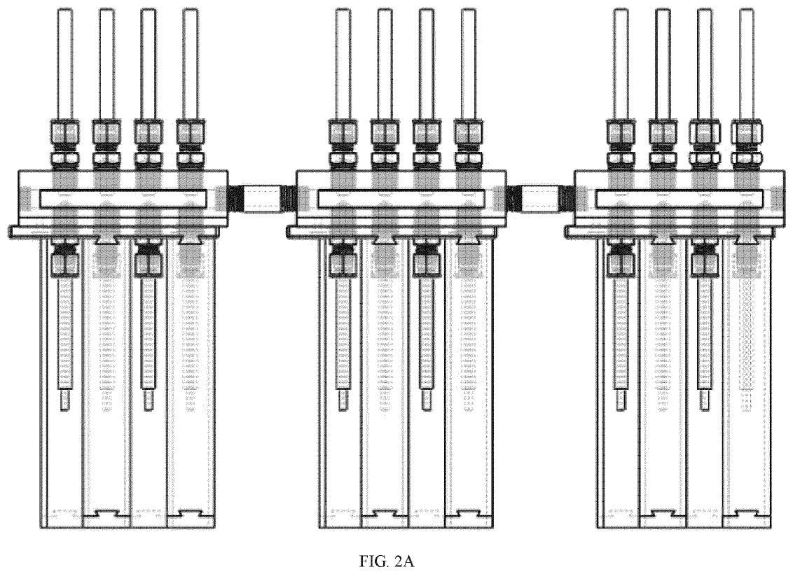

Provided herein are various embodiments of a reactor that provides a very high pulsing frequency. A high enough liquid flow rate is maintained in the reactor to sustain that pulsing frequency while maintaining optimal plasma parameters. Ordinary batch reactors proposed in other patents are maintained at around 10-20 pulses/sec (pulses per second). At around 20-30 mJ/pulse (milli Joules per pulse) and small volume of the batch reactor (about 10-20 grams (g)) the pulsing frequency is feasible for target energy deposition. However, for industrial scale processing of, for example, about a barrel per day, a significantly higher pulsing frequency needs to be achieved to reduce the processing time of such high feedthrough of liquid hydrocarbon. To maintain such high pulsing frequency of spark discharge, various embodiments ensure that gas is not trapped in between the electrodes. Trapped gas in between the electrode at high frequency will lead to glow discharge which is undesirable for hydrocarbon reforming. Hitting the same gas bubbles with multiple discharges simultaneously (or in rapid progression) leads to overprocessing of the gas-liquid hydrocarbon mixture, thereby producing increased soot formation (e.g., by removing the carbon molecules from the hydrocarbon chain). Thus, a high flow rate is necessary. Liquid needs to move faster compared to the residence time between the electrodes to avoid the same gas bubbles being hit by more than one discharge. Therefore, high fluid velocity is ensured in the inter electrode gap. An illustration of a high fluid capacity system is shown in FIG. 1. Too high of a flow rate would lead to cavitation, wherein the local fluid pressure would be reduced below the vaporization pressure of the liquid. In a multiphase reactor, where a high hydrogen content donor gas is processed with a relatively low hydrogen content recipient liquid, it is beneficial for the gas phase to be the donor gas.

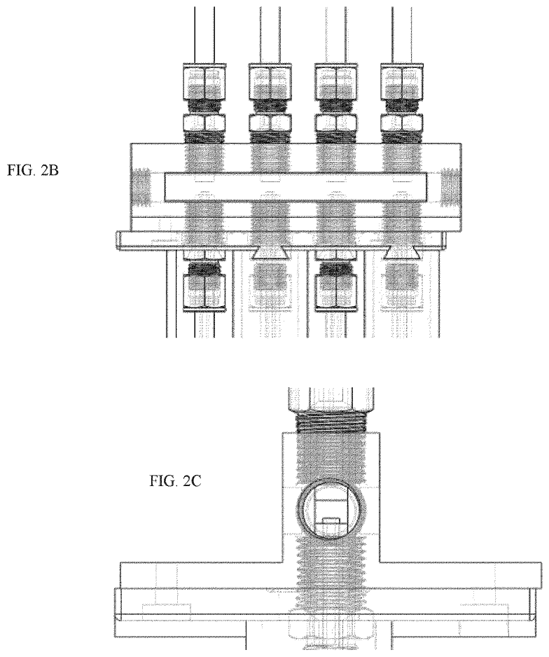

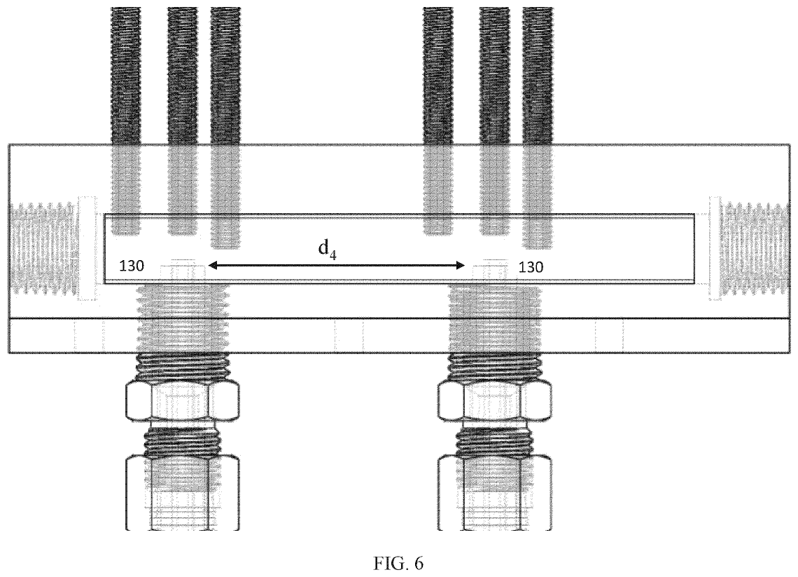

In various embodiments, a single reactor unit may house multiple spark gaps lined up in the direction of the flow without interacting each other's discharge phenomenon. The spark gap may be, for example, between 0.2 and 3 centimeters (e.g., electrodes about 0.25 inches apart, 0.5 inches apart, or about 1 inch apart), or between about 3 mm and about 10 mm. Distance (d₂) between 130 and 105 can be, for example, between 1 cm and 3 cm. The distance between electrode pairs (e.g., from one 130 to an adjacent 130 going from upstream to downstream, depicted as d₄ in FIG. 6) may be, for example, between about 0.5 cm to about 6 cm (e.g., about 1 cm). In various embodiments, closer spacings (i.e., smaller d₄ values) would allow for a higher processing intensity (kW/m\hat{ }3). However, spacings (i.e., d₄ values) that are too small can result in interference from one discharge to another. In example embodiments, the distance between 130s (i.e., d₄ values) can be about 0.5 cm or about 1 cm or between about 2 cm and about 3 cm, whereas longer distances (e.g., 5 cm or 6 cm) would tend to be significantly less efficient and less intense. The values for d₁ (inner diameter) can vary, for example, from about 50 microns to about 6 mm or to about ⅛ in, in various embodiments. The values for d₃ (vertical distance) can be, for example, less than 2 cm (e.g., between about 0.2 cm and about 2 cm), in various embodiments. In various embodiments, values for d₂ and d₃ are consistent with the breakdown voltage of the multiphase mixture. The number of spark gaps may vary depending on the target experimental condition. Too high number of spark gaps in series might over process the liquid hydrocarbon by depositing more than enough energy in a single pass. In various embodiments, the high voltage electrode of each electrode gap is connected to an efficient Cockcroft-Walton Generator circuit (or other high voltage (HV) low energy per pulse generating circuit) which produces spark discharge for hydrocarbon conversion using a high-voltage rectified DC supply. The circuit is optimized to minimize waste energy by operating at constant voltage, approximately constant current, or constant power mode, operating off a standard electrical supply line (e.g., 120 VAC or 240 VAC, 60 Hz, single phase or multiphase). A reactor with multiple spark gaps is shown in FIG. 2. In various embodiments, multiple reactors can be added in series or parallel as well. Alternative embodiments could have any number of reactor modules (alternatively referred to herein as “reactor units”) in series, each reactor module having multiple spark gaps.

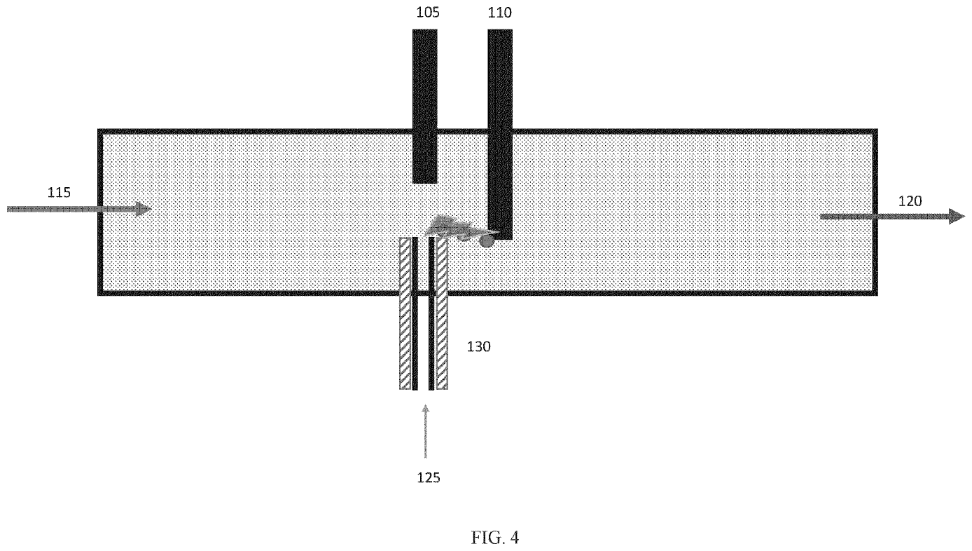

In various embodiments, the wetted cross-sectional area of the discharge chamber is designed to achieve the targeted liquid flow rate. In an example embodiment of the present technology, the cross-sectional dimension (e.g., with reference to FIG. 4, the cross-section is with respect to the height and depth into the page) of the example chamber is about 0.25 inch by about 0.46 inch. The high voltage electrode may be an approximately ⅛ inch stainless steel hollow rod covered in, for example, an about 0.25 inch OD (outer diameter) insulator. The insulating material might be alumina, Teflon, or another insulating material. The ground electrode may be, for example, an about 0.25 inch solid stainless-steel, or other conductive and corrosion resistant metal, rod. The electrode gap can be varied up to, for example, about 10 mm (millimeters). Higher electrode gap will lead to higher breakdown voltage. Fluid velocity in between the electrodes can be calculated from selected system parameters. In various embodiments, the cross-sectional area of the chamber can vary from about 0.25 in² (e.g., dimensions of about 0.25 in by about 0.25 in) to about 1 in² (depending on, e.g., bubble growth size). For chambers that are multi-phase (e.g., liquid and gas), these dimensions could correspond to the cross-section of the liquid phase within the multi-phase chamber. It is noted that smaller dimensions can provide higher velocities. In various embodiments, the cannula or inner pipe diameter controls, at least to a degree, the bubble size. In various embodiments, values for d₁ may be between about 50 μm and 6 mm. If d₁ values are too small, this could result in clogs, and if d₁ values are too large, this could result in big bubbles that are too large and the liquid may not be processed.

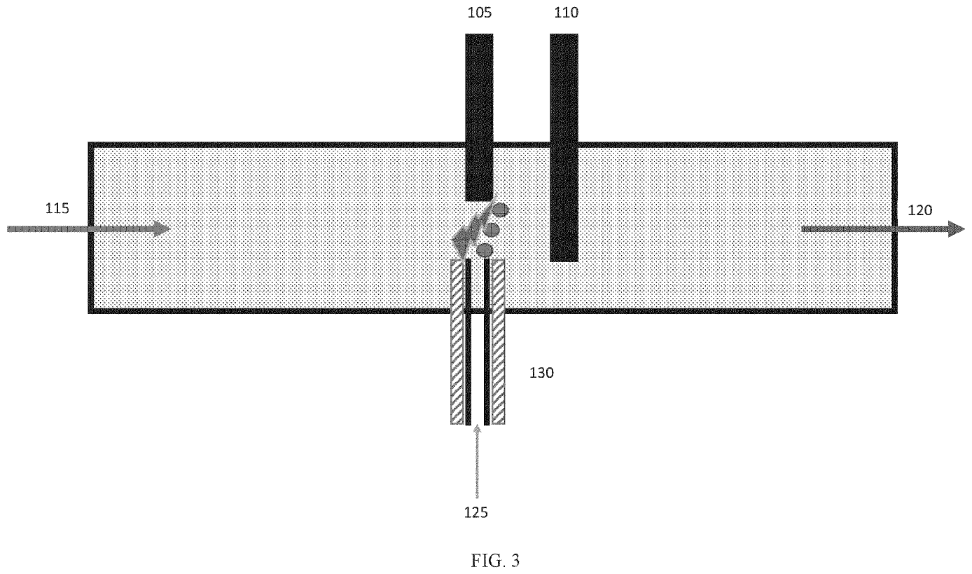

In various embodiments of the system, two ground electrodes are placed because the high velocity of the liquid will not allow the gas bubbles from the capillary to move straight up. Instead, the stream of gas bubbles will be slanted to the direction of flow and in extreme cases they will move horizontally in line with the liquid. In some examples, a second ground electrode (ground electrode 2) may be placed in the direction of flow (d₂) at a distance (d₃) same as the vertical gap between HV and a first electrode (ground electrode 1). In other embodiments, d₂ and d₃ are not equal and ranging and different values as discussed herein. However, discharge is still possible between HV and ground electrode 1 since the liquid hydrocarbon will carry gas bubbles from the upstream electrode gaps. These two possible phenomena are depicted in FIGS. 3 and 4. As shown in FIGS. 3 and 4, in various embodiments, the electrodes are placed in a specific configuration relative to the flow and gas injection. A discharge to the first ground electrode, directly opposite the gas injection, would occur at relatively lower velocities of the liquid. A discharge to the second ground electrode, downstream of the gas injection, would occur at relatively higher velocities of the liquid. The distance which the bubbles are convected downstream depends on the upward buoyancy on the bubble and the lateral flow velocity. In certain tested conditions the fluid velocity was about 1 m/s (meters per second) and the gas flow through the capillary was about 25 sccm (standard cubic centimeters per minute) discharges occurred predominantly to the second electrode which was located 3 mm downstream from the gas injection. In other embodiments, only a single ground electrode is needed and that location downstream of the gas injection can be determined by visualizing, or modeling, the angle of the stream of gas bubbles during high speed flow. The applied voltage, and breakdown voltage of the multiphase system also determines the maximum distance downstream that the electrode can be placed relative to the gas injection electrode. In other embodiments, the polarity of the electrodes could be reversed. In other embodiments the potential of the electrodes relative to ground could be altered while still maintaining the required electric field for breakdown in the multiphase gap.

Gas bubble residence time will depend on the phenomena that the discharge follows. If it follows the first phenomenon (FIG. 3) then the maximum allowable pulsing frequency will depend upon the diameter of the HV electrode. Assuming liquid flow rate Q (liter/min) and cross-sectional area, A (meters squared (m²)). Hence, the fluid velocity:

$$V = ( 1.665 e - 5 ) Q / A m / sec$$

At fluid velocity ‘V’ and ‘d₁’ inch of high voltage electrode diameter, the residence time of fluid in the electrode gap is:

Residence time,

$${t}_{1} = \frac{{d}_{1}}{V} \frac{inch}{m / sec} = \frac{0.0 \; 254 {d}_{1}}{( 1.665 e - 5 ) Q / A} \frac{m}{m / sec} = 1525.5 \frac{{d}_{1} A}{Q} sec$$

Hence, maximum pulsing frequency f to avoid hitting the same liquid particle with consecutive discharges for these conditions is:

$${f}_{1} = ( 6.5 e - 4 ) \frac{Q}{{d}_{1} A} Hz$$

However, if the discharge follows the second phenomenon (FIG. 4) then the residence time of gas bubble hence the maximum pulsing frequency will depend on the electrode gap d₂. The maximum pulsing frequency will be:

$${f}_{2} = ( 6.5 e - 4 ) \frac{Q}{{d}_{2} A} Hz$$

If electrode gap (d₂) is bigger than the electrode diameter (d₁), f₂ will be smaller than f₁. Since there are possibility of breakdown happening following both phenomena, the maximum pulsing frequency will have to the smaller of the two, f₂.

Higher liquid flow rate ‘Q’ will allow for higher allowable pulsing frequency for the similar reactor geometry.

From the parameters chosen for this analysis, A=3 mm*0.25 in=19.05 mm²=1.905e-5 m²:

| | | |
|---|---|---|
| Cross sectional | 19.05 mm² | 1.905 × 10⁻⁵ m² |
| area (A) | | |
| If the flow rate | | |
| is 5 L/min (P) | | |
| Flow Rate (ρ) | AV | |
| Fluid Velocity (V) | V = ρ/A = | P = 5 liters/ |
| | (8.3 × 10⁻⁵)/(1.905 × 10⁻⁵) = | minute |
| | 8.3 × 10⁻⁵ m³/sec = | |
| | 4.37 m/sec. | |

At 4.37 m/s fluid velocity and ⅛ inch high voltage electrode size, for example, the residence time of fluid in the electrode gap is residence time, t, is (3 mm)/(4.37 m/s)=(0.003 m/4.37 m/s), which equates to 6.86×10⁻⁴ seconds. Hence, maximum pulsing frequency is 1/t=1457 Hz to avoid hitting the same liquid particle with consecutive discharges for these conditions. Higher liquid flow rate therefore will allow for higher pulsing frequency for the similar reactor geometry. This pulsing frequency is enough to significantly reduce the processing time of high throughput of liquid hydrocarbon. Each parameter, flow rate, channel dimension, number of discharge gap in series etc., is chosen in such a way to maximize this allowable pulsing frequency and total energy deposition in the hydrocarbon per pass. Too low a frequency is undesirable because, on each pass through the reactor, the energy deposited to the liquid (and gas) will be too small a fraction of the overall desired specific energy input required to meet a reasonable conversion. Low frequency could be overcome by multiple passes through the same reactor or multiple reactors. Both of these alternatives would result in a larger volume and higher capital cost processing system. High frequency is thus desirable to make a more compact system. Too high a frequency is undesirable unless the flow rate is increased to ensure that over processing of the same bubble or product does not occur, as discussed earlier.

For a stationary fluid reactor this pulsing frequency to avoid trapping a gas bubble between the electrodes is over a magnitude smaller and thus allows for much slower processing. The geometry of the flow channel is chosen to achieve the appropriate high velocity flow. Velocity is equal to flow rate divided by cross sectional area of the channel.

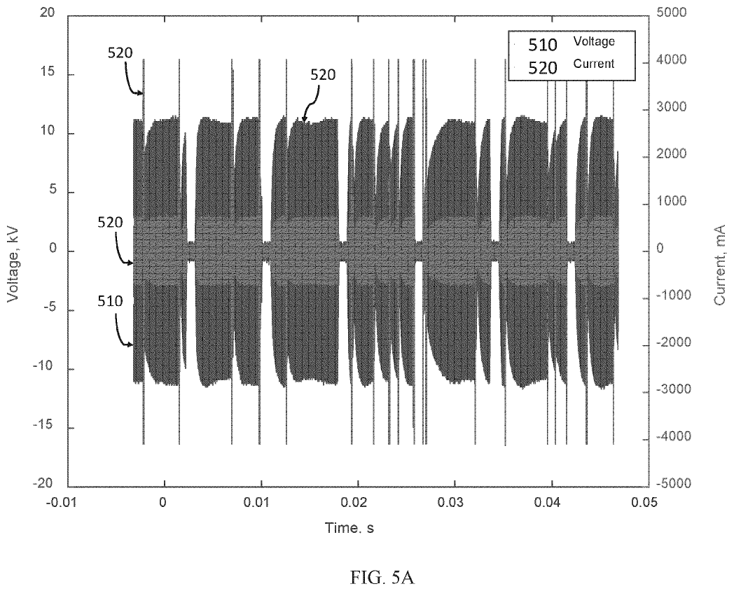

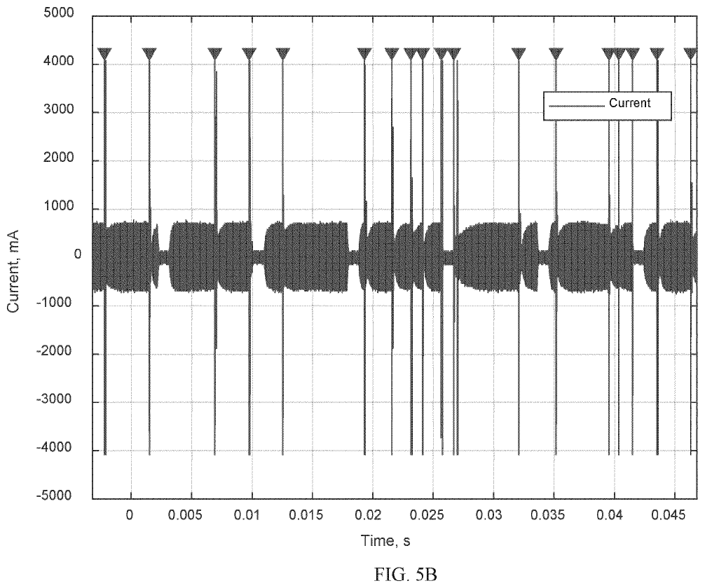

FIG. 5 illustrates a voltage and current trace from a reactor with 10 spark gaps. The trace can be used to measure the pulsing frequency of the reactor. In this particular case, the pulsing frequency in the reactor was 359 Hz. This is limited by the power supply and pump for circulating the liquid hydrocarbon in the system loop.

High voltage stainless steel electrodes are capillaries and are connected to gas feed lines regulated by flow controllers. Flow into each of the spark gaps can be controlled using the flow controllers according to gas to liquid ratio that is intended to be maintained. With same flow rate through each of the capillaries, the gas to liquid ratio at the downstream of the series of spark gaps will be higher compared to the upstream ones. This will change the breakdown behavior of the downstream spark gaps since breakdown voltage is different for different ratio of gas to liquid multiphase mixture.

The present technology can also be used by flowing gas though only one upstream capillary and not having capillaries at every electrode. In this configuration, the upstream capillary injected carrier gas flows through all the discharge gaps and are accompanied by the gases generated in rest of the discharge regions. This phenomenon has also been tested in a reactor as shown in FIG. 6 where flow is controlled by the upstream capillary and discharge observed at both upstream and downstream electrode gap. The use of a reduced number of gas injection capillaries is potentially advantageous because the flow control system is simplified. However, too few gas injection capillaries will result in either an unreliable breakdown process as the gas doesn't align with the discharge gaps, or an undesirable discharge process wherein product gas is processes rather than raw feed gas.

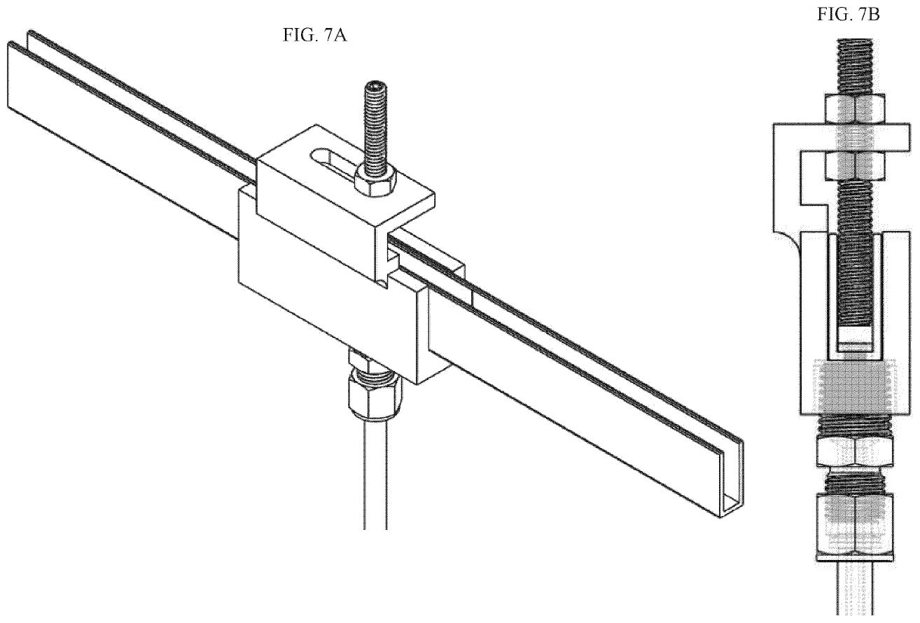

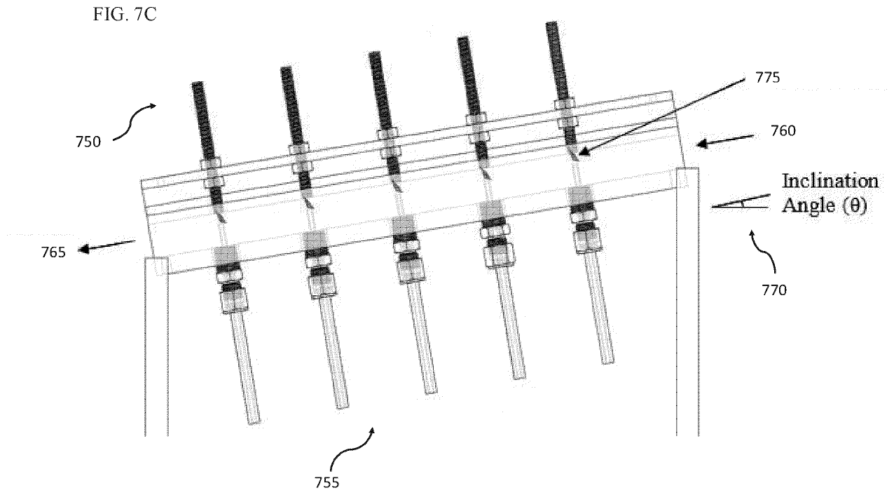

High flow rate of liquid hydrocarbon can also be ensured with open channel flow (FIG. 7). The channel can be tilted at a certain angle to ensure gravity driven flow of liquid hydrocarbon. The angle will depend at least in part on characteristics of the hydrocarbons (e.g., viscosity, temperature, etc.). In various examples, the angle can be any value less than 90 degrees (e.g., from about 5 degrees to about 85 degrees, higher angles tending to allow for higher velocities). This will allow for the capillary gas and gas generated during the chemical reforming by spark discharge to leave and not interfere with the discharge in the rest of the spark gaps. Open channel flow can be modified to a pressure driven flow instead of gravity driven by introducing the flow into the channel with a nozzle and flowing at very high pressure.

Discharge in an open channel is characterized by the following equation:

$$Q = \frac{{gS}_{o} {by}_{n}^{3}}{3 v} [ {\sum }_{n = 0}^{∞} 1 - \frac{384}{{π}^{5}} \frac{{y}_{n}}{b} {( 2 n + 1 )}^{- 5} tanh ( \frac{2 n + 1}{4} \frac{π b}{{y}_{n}} ) ]$$

where, Sₒ is the bed slope, v is the kinematic viscosity of the fluid, yₙ is the normal depth of the flow, b is the bed width, and g is gravitational acceleration.

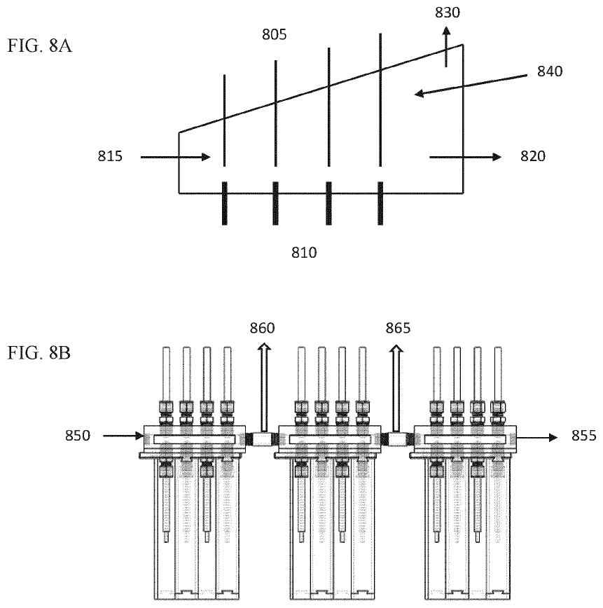

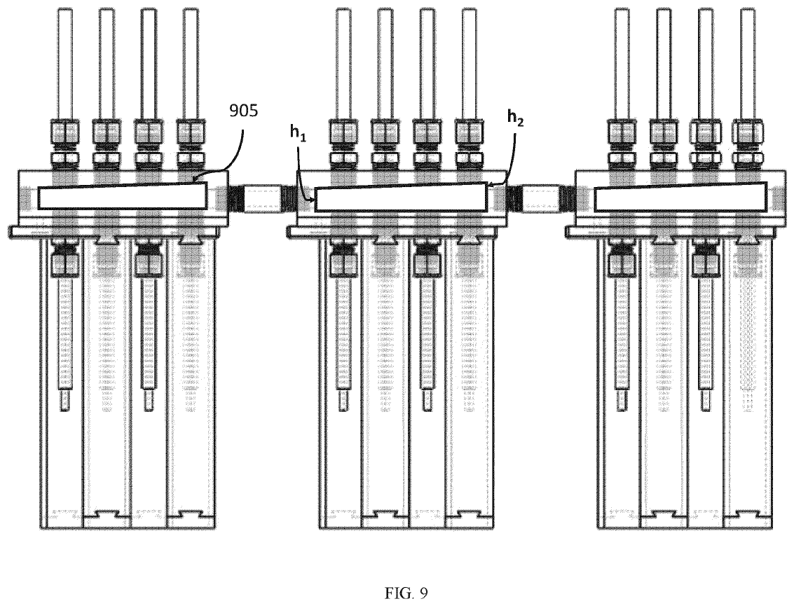

Another embodiment of the system is having a reactor with varying headspace along the reactor. Since each spark gap produces gaseous products, cumulative gas fraction at the end of the reactor will be much higher than the beginning of the reactor (FIG. 8A). This can be solved by having an increasing headspace along the downstream of the channel to allow for newly generated gaseous hydrocarbons. Produced gaseous hydrocarbon along the channel can also be taken out of the reactor after every few spark gaps through gas off-take valves (FIG. 8B). The variation in head space and spacing of gas off takes relative to gas generating discharge gaps can be calculated based on the product conversion occurring at each discharge gap.

If V_{new} is the new volume after discharge and V_{old} is the initial volume, then: V_{new}=V_{old} (1+V_{increase}). In this equation, V_{increase} is the percentage increase in volume after the processing (i.e. the function—power, pulsing frequency, and gas flow rate).

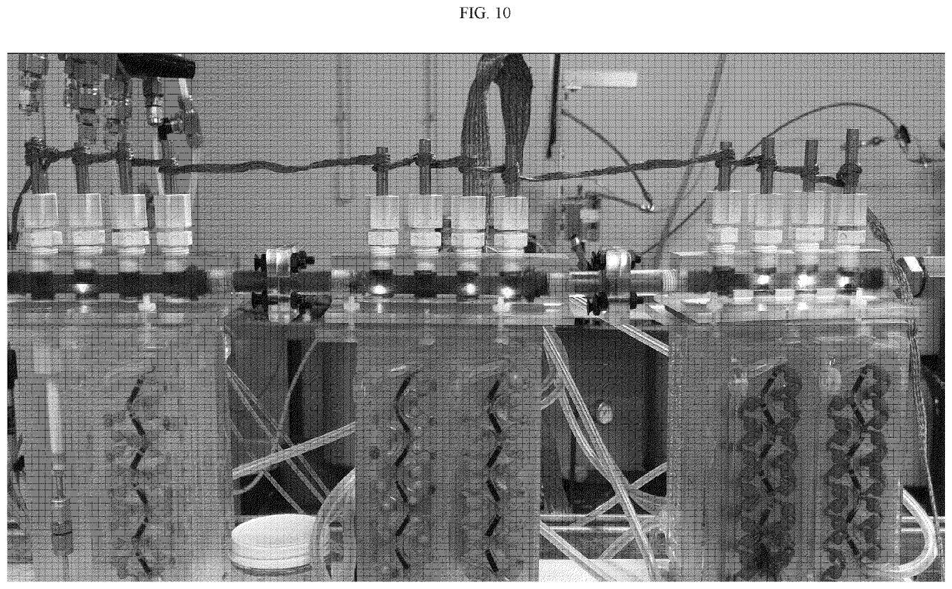

Experimental analysis: FIG. 10 shows an operational prototype of an example reactor with multiple electrode gaps being lit with plasma discharge. Gas and liquid are flowing from left to right. If tuned properly, all twelve electrode gaps can run simultaneously. However, in reality at certain instances depending on the presence of bubble between the electrode gaps some gaps might be more probable of breaking down compared to others. Corona leak can be mitigated by submerging power packs to a non-conductive liquid sink such as mineral oil.

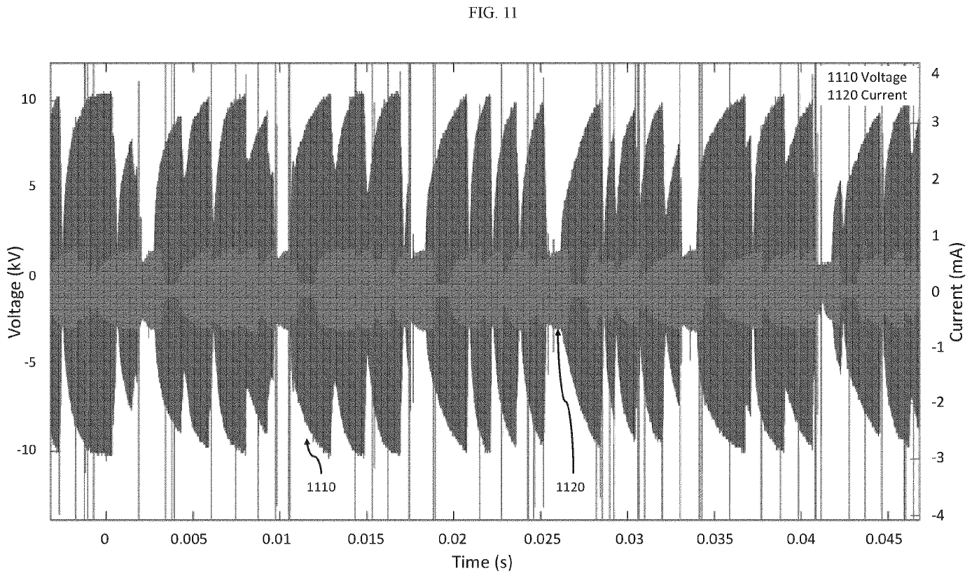

A 500 kJ/kg energy deposition experiment was attempted in the reactor. Pulsing frequency during the experiment was had an average of around 600 Hz for the first 20 minutes of the 2.5 hours experiment and around 1000 Hz for the rest. The voltage and current reading in FIG. 11 is at the exit of the AC power supply and at the inlet of the CWG power packs. CWG power packs can up the voltage according to the number of steps used in the CWG setup. The CWG used in this experimental setup is a two-step CWG. Assuming a 10 mJ energy per pulse the total energy deposition may be around a third of the intended 500 kJ/kg.

### REFERENCES

[1] BP Statistical Review of World Energy. 2021. [2] BP BP Energy Outlook. 2020. [3] Hammoudeh, S. and J. C. Reboredo, Oil price dynamics and market-based inflation expectations. Energy Economics, 2018. 75: p. 484-491. [4] Rollier, J.-D., et al., Experimental study on gasoline reforming assisted by nonthermal arc discharge. Energy & Fuels, 2008. 22(1): p. 556-560. [5] Li, M.-W., Y.-L. Tian, and G.-H. Xu, Characteristics of carbon dioxide reforming of methane via alternating current (AC) corona plasma reactions. Energy & fuels, 2007. 21(4): p. 2335-2339. [6] Matsui, Y., et al., Liquid-phase fuel re-forming at room temperature using nonthermal plasma. Energy & fuels, 2005. 19(4): p. 1561-1565. [7] Hao, H., et al., Non-thermal plasma enhanced heavy oil upgrading. Fuel, 2015. 149: p. 162-173. [8] Tu, X. and J. Whitehead, Plasma-catalytic dry reforming of methane in an atmospheric dielectric barrier discharge: Understanding the synergistic effect at low temperature. Applied Catalysis B: Environmental, 2012. 125: p. 439-448. [9] Ishmukhametov, A. Z., et al., Method for cracking, unification and refining of hydrocarbons and device for its implementation. 26 Apr. 2011, U.S. Pat. No. 7,931,785. [10] Novoselov, Y., Process for cracking of liquid hydrocarbon materials by pulsed electrical discharge and device for its implementation. 5 Jun. 2018, U.S. Pat. No. 9,988,579. [11] Staack, D. and K. Wang, Submerged methane and hydrogen mixture discharge in liquid hydrocarbons. Apr. 19, 2019, Publication No US 2021/0155855 A1. [12] Wang, K., et al., Electric fuel conversion with hydrogen production by multiphase plasma at ambient pressure. Chemical Engineering Journal, 2022. 433: p. 133660. [13] Wang, K., et al., CO₂-free conversion of fossil fuels by multiphase plasma at ambient conditions. Fuel, 2021. 304: p. 121469. [14] Wang, K., et al., Relative breakdown voltage and energy deposition in the liquid and gas phase of multiphase hydrocarbon plasmas. Journal of Applied Physics, 2021. 129(12): p. 123301. [15] Wang, K., et al., Role of bubble and impurity dynamics in electrical breakdown of dielectric liquids. Plasma Sources Science and Technology, 2021. 30(5): p. 055013. [16] Staack, D., et al., Foaming system for efficient plasma processing of heavy hydrocarbon. 23 Sep. 2021, Publication Number WO/2021/188650. [17] Staack, D., et al., Efficient circuit in pulsed electrical discharge processing, Publication Number WO/2019/204736, discussing features and benefits of Cockcroft-Walton circuits (e.g., Cockcroft-Walton generator (CWG)), incorporated herein by reference.

While certain embodiments have been illustrated and described, it should be understood that changes and modifications can be made therein in accordance with ordinary skill in the art without departing from the technology in its broader aspects as defined in the following claims.

The embodiments, illustratively described herein may suitably be practiced in the absence of any element or elements, limitation or limitations, not specifically disclosed herein. Thus, for example, the terms “comprising,” “including,” “containing,” etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified.

The present disclosure is not to be limited in terms of the particular embodiments described in this application. Many modifications and variations can be made without departing from its spirit and scope, as will be apparent to those skilled in the art. Functionally equivalent methods and compositions within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions, or biological systems, which can of course vary. It is also to be understood that the terminology used herein is for the purpose of describing particular embodiments only, and is not intended to be limiting.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like, include the number recited and refer to ranges which can be subsequently broken down into subranges as discussed above. Finally, as will be understood by one skilled in the art, a range includes each individual member.

All publications, patent applications, issued patents, and other documents referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict definitions in this disclosure.

Other embodiments are set forth in the following claims.

What is claimed is:

1. An apparatus for reforming hydrocarbons, the apparatus comprising:
a reaction chamber comprising:
a hydrocarbon inlet;
a plurality of plasma gaps, each plasma gap being defined by a high voltage electrode and a first and second ground electrode; and
a product outlet;
wherein:
the reaction chamber has a first head space surrounding a first plasma gap located proximal to the hydrocarbon inlet;
the reaction chamber has a second head space surrounding a last plasma gap located proximal to the product outlet; and
the second head space is larger than the first head space.

2. The apparatus of claim 1, wherein the reaction chamber comprises a sloped headspace from the hydrocarbon inlet to the product outlet.

3. The apparatus of claim 1, wherein the high voltage electrode is connected to a pulsed power source configured to deliver a pulsed discharge in the plasma gap of 300 to 1000 Hz.

4. The apparatus claim 1, wherein a first ground electrode is directly opposing and spaced apart from the high voltage electrode by a gap distance, d, and the second ground electrode is offset to the side of the high voltage electrode also by the gap distance, d.

5. The apparatus of claim 1, wherein the reactor chamber is a first reaction chamber of a first reaction module, and wherein the apparatus further comprises a second reaction module having a second reaction chamber, the first reaction module connected to the second reaction module.

6. The apparatus of claim 5, wherein the hydrocarbon inlet is a first hydrocarbon inlet of the first reactor module, wherein the product outlet is a first product outlet of the first reactor module, wherein the second reactor comprises a second hydrocarbon inlet and a second product outlet, and wherein the first product outlet is connected to the second hydrocarbon inlet by a conduit.

7. The apparatus of claim 5, wherein:
the first reaction module is connected to the second reaction module by a first conduit comprising a first gas off-take; and
the apparatus further comprises a third reaction module connected to the second reaction module by a second conduit comprising a second gas off-take.

8. The apparatus of claim 5, wherein:
the hydrocarbon inlet is a first hydrocarbon inlet of the first reactor module;
the product outlet is a first product outlet of the first reactor module;
the first reaction chamber comprises a first sloped headspace from the first hydrocarbon inlet to the first product outlet; and
the second reaction chamber comprises a second sloped headspace from a second hydrocarbon inlet to a second product outlet.

9. A reactor system comprising a plurality of the apparatus of claim 1, wherein between any two adjacent apparatuses is located a conduit from which gas may be exited from the system.

10. A method for reforming hydrocarbons, the method comprising:
introducing a C₁-C₄ hydrocarbon to a reaction chamber, wherein the reaction chamber comprises:
a hydrocarbon inlet;
a plurality of plasma gaps, each plasma gap being defined by a high voltage electrode and a first and second ground electrode; and
a product outlet;
applying a pulsed power source at a frequency of about 300 Hz to about 1000 Hz to each of the high voltage electrodes in the reaction chamber to form a plasma discharge at each plasma gap and to form a product stream comprising hydrocarbons having greater than C₄.

11. The method of claim 10, wherein the reaction chamber has a first head space surrounding a first plasma gap located proximal to the hydrocarbon inlet, the reaction chamber has a second head space surrounding a last plasma gap located proximal to the product outlet, and the second head space is larger than the first head space.

12. The method of claim 10, wherein the frequency is about 500 Hz to about 1000 Hz.

13. The method of claim 10, further comprising determining a velocity for the introduction of the C₁-C₄ hydrocarbon to the reaction chamber.

14. The method of claim 10, further comprising determining the frequency for applying the pulsed power source.

15. The method of claim 10, wherein the reaction chamber has a headspace that is greater at the hydrocarbon inlet of the reaction chamber than at the product outlet of the reaction chamber.

16. The method of claim 10, wherein the reaction chamber comprises a sloped headspace from the hydrocarbon inlet to the product outlet.

17. The method of claim 10, wherein the reaction chamber is a first reaction chamber of a first reaction module, wherein the hydrocarbon inlet is a first hydrocarbon inlet, wherein the plurality of plasma gaps is a first plurality of plasma gaps, wherein the product outlet is a first product outlet, wherein introducing the C₁-C₄ hydrocarbon to the first reaction chamber introduces the C₁-C₄ hydrocarbon to a system comprising the first reaction module and a second reaction module having a second reaction chamber with a second hydrocarbon inlet and a second product outlet, wherein the product stream is received from the second product outlet.

18. The method of claim 17, wherein the first reactor module is connected to the second reactor module by a conduit comprising a gas off-take to release at least a portion of gas generated in the first reaction chamber.

19. The method of claim 18, wherein the system further comprises:
a first conduit connecting the first reaction module to the second reaction module, the first conduit having a first gas off-take;
a third reaction module connected to the second reaction module by a second conduit having a second gas off-take.

20. The method of claim 19, wherein the reaction chamber is a first reaction chamber of the first reaction module, wherein the second reaction module includes a second reaction chamber, and wherein the first and second reaction chambers include headspaces that increase in size from inlet to outlet.
